(19) United States
(12) Patent Application Publication
(10) Pub. No.: US 2013/0046548 A1
(43) Pub. Date: Feb. 21, 2013

(54) PARLIAMENTARY PROCEDURE TOOLS

(71) Applicant: James H. Snider, Severna Park, MD (US)

(72) Inventor: James H. Snider, Severna Park, MD (US)

(21) Appl. No.: 13/214,153

(22) Filed: Aug. 19, 2011

(51) Int. Cl. G06Q 10/00

(52) U.S. Cl. 705/1.1

(57) ABSTRACT

Computer-implemented architectures and interfaces for automating aspects of parliamentary procedures provide dynamic context-sensitive information and/or guidance to group members so that even a limited understanding of the parliamentary procedure can be sufficient to participate in a meeting. Additionally, automated recordation of parliamentary actions, including metadata and links to external data, facilitates records research and informs future parliamentary action decisions.

### FIELD

The present invention relates generally to tools for parliamentary procedures, and more specifically to methods and apparatus for managing, informing, recording, automating and/or networking meetings which are administered with parliamentary procedures.

### BACKGROUND

America has millions of decision making bodies that use verbally well-defined to decision making rules to run their meetings. Although these bodies are extraordinarily diverse, their decision making rules tend to be based on a relatively small and uniform repertoire of options.

The various types of groups with formal decision making rules (hereinafter, “bodies”) can be divided into public and private bodies. An example of a public body is Congress; an example of a private body is a shareholders' meeting of a Corporation.

Public bodies can be subdivided into federal, state, and local bodies. The vast majority of public bodies are located at the local level of government. There are more than 89,000 political jurisdictions in the U.S. At the local level, some public bodies are relatively high profile, such as the tens of thousands of school boards and town councils. However, the vast majority are relatively low profile such as library commissions, pension commissions, ethics commissions, housing commissions, and charter revision commissions. A large municipality may have thirty or more such public bodies. In small towns that have town meetings, the entire voting age population of the town may constitute the public body.

Public bodies can be further subdivided between those subject to formal open meeting laws and those that follow formal procedures but are not subject to such laws. The various commissions described above fit into the former category. Nominally public advisory committees, such as those appointed by a public school superintendent to advise on issues such as school calendars, block scheduling, and a health & wellness curriculum, fit into the latter category.

Private bodies can be subdivided into for-profit and non-profit bodies. For-profit bodies include shareholder meetings and meetings of boards of directors.

Non-profit bodies come in enormous variety in the U.S., including clubs, religious institutions, educational institutions, trade associations, and civic groups. Almost every industry and group of professionals has one or more trade association. Non-profit civic groups exist at almost every level of American life, ranging from condominium and homeowner associations that operate at a hyper local level to giant groups such as the National Rifle Association, Common Cause, and the League of Women Voters which operate at multiple levels of government up to the national level and may have hundreds of local chapters.

Governments may mandate meeting procedures for public corporations and non-profits just as it mandates open meeting laws for public bodies. Examples include meetings of legally mandated boards of directors and annual shareholder/member meetings. Group decisions made through a parliamentary authority are often treated by the government as legally binding contracts.

Overall, America has more than a million groups that rely on some type of formal decision making rules. During the course of a year, most Americans will participate in such a group, even if it is only their local PTA, condo association, or church. During the course of a year, this adds up to billions of hours spent in such meetings.

Ongoing, well-defined groups typically rely upon some organized system of rules, often called a “parliamentary authority,” for conducting group decisions. Robert's Rules of Order is the most widely used set of group decision making rules, but there are dozens of others as well. Each set of rules is typically derived from one or more other set. For example, John Hatsell, clerk of the British House of Commons, published in 1776 a manual of parliamentary procedure for the British House of Commons. Thomas Jefferson, primary author of the U.S. Declaration of Independence, published in 1801 a manual of parliamentary procedure for the U.S. Senate which was later adopted by the U.S. House of Representatives. Luther Stearns Cushing, former clerk of the Massachusetts House of Representatives, published in 1845 a manual of parliamentary procedure for state legislatures. Henry Martyn Robert, a former U.S. General and the “Robert” in Robert's Rules, published in 1876 a manual of parliamentary procedure for general use among private and relatively simple public bodies.

Each of these manuals was derived from the earlier manuals. For example, Robert's Rules of Order can be seen as evolving from Hatsell's, Jefferson's and Cushing's manuals. Robert's Rules of Order has, in turn, been used as a basis for countless sets of parliamentary rules included in organizational bylaws. Widely used parliamentary authorities today include Robert's Rules of Order, Mason's Manual of Parliamentary Procedure, and The Standard Code of Parliamentary Procedure.

### SUMMARY

To be effective in many spheres of life, an individual must work through groups, which is why America has millions of different government, non-profit, and for-profit groups. But merely working through groups is not sufficient—one must also know how to work within groups. Here, knowledge of formal group decision making rules (“parliamentary procedure”) can be a great help.

Unfortunately, knowledge of parliamentary procedure has been difficult to both memorize and apply. Knowledge of parliamentary procedure is thus often regarded as an arcane skill, reflected in the fact that fewer than 1% of adults in many communities feel comfortable, let alone have a high level of expertise, in using parliamentary procedure. This lack of comfort and knowledge has harmful consequences for both individuals and groups, including increasing the costs and decreasing the benefits of participating in groups.

High costs result in less participation by individuals and less effective groups. Individuals are less likely to participate in an existing or potential group when they lack the skills to participate effectively. And groups without members who are knowledgeable in using parliamentary procedure are likely to be less effective.

High costs also tend to aggravate injustice. As the costs rise, fewer people are willing to bear the cost of learning parliamentary procedure, resulting in the unequal distribution of such knowledge among group members. This unequal distribution may not only be unfair to the individual, but also reduce the legitimacy and thus the effectiveness of the group. These effects are especially true of groups designed to be democratic, where each individual is supposed to have an equal voice in decision making. When a group, such as the U.S. Congress, consists of members highly knowledge in parliamentary procedure and all members have free access to expert parliamentarians, the asymmetric distribution of knowledge is relatively small. But such groups are rare.

Insofar as efficient and just group decision making is critical to maximizing the social welfare of a modern society, any technology that can significantly increase this efficiency would be a great boon. One of the benefits of embodiments described herein is the dramatic reduction of both group decision making costs and the injustice that is a consequence of those high costs. Other potential benefits are multifaceted and transformative.

In the future, decision making rules are likely to become mathematically as well as verbally well defined. This definition will allow machine readability and many new opportunities to enhance group decision making processes.

According to some embodiments, a program provides dynamic context-sensitive information and/or guidance to group members regarding a parliamentary procedure so that even a limited understanding of the parliamentary procedure can be sufficient to participate in a meeting. In some embodiments, a networked computer system provides dynamic tracking and recording of parliamentary procedure so that group members can follow and review meeting progress. In other embodiments, an automation of recording a meeting, including video of speakers, can be implemented.

Aspects of the invention are not intended to be construed narrowly in view of the illustrative embodiments. In addition, it should be understood that aspects of the invention may be used alone or in any suitable combination with other aspects of the invention.

According to one embodiment of the invention, a computer-readable storage medium is encoded with a plurality of instructions that, when executed by a computer, perform a method. The method includes receiving an indication of a first parliamentary action, based on at least the indication of the first parliamentary action, determining one or more available parliamentary actions which would be compliant with a defined set of parliamentary rules, and outputting an indication of at least one of the one or more available parliamentary actions. In some embodiments, this method may be performed on a networked computer system.

According to another embodiment of the invention, A computer system includes at least one processor programmed to receive an indication of a first parliamentary action from a first client device, determine one or more available parliamentary actions based on the first parliamentary action, and send an indication of the first parliamentary action and an indication of the one or more available parliamentary actions to a plurality of client devices.

According to a further embodiment of the invention, a computer network includes a first electronic device configured to receive indications of parliamentary actions inputted by other electronic devices, and further configured to maintain a display of at least some of the inputted parliamentary actions. The computer network also includes a second electronic device configured to receive indications of parliamentary actions inputted by other electronic devices, and further configured to maintain a display of at least some of the inputted parliamentary actions. The first electronic device is to configured to permit a first user to indicate a first parliamentary action, and further configured to input the first parliamentary action by sending an indication of the parliamentary action, and the second electronic device is configured to permit a second user to indicate a second parliamentary action, and further configured to input the second parliamentary action by sending an indication of the second parliamentary action.

According to another embodiment of the invention, a computer system includes at least one processor programmed to receive an indication of a first parliamentary action, compare the first parliamentary action to a defined set of parliamentary rules stored on a computer storage medium, and determine whether the first parliamentary action complies with the defined set of parliamentary rules. If the first parliamentary action does not comply with the defined set of parliamentary rules, the processor is programmed to output an alert regarding non-compliance with the rules.

According to yet another embodiment of the invention, a computer-readable storage medium is encoded with a plurality of instructions that, when executed by a computer, perform a method including receiving an indication of a first parliamentary action and receiving an indication of a second parliamentary action. The method further includes recording, on a computer storage medium, the existence of the first parliamentary action, and recording, on the computer storage medium, meta-data associated with the first parliamentary action. Also included in the method are acts of recording, on a computer storage medium, the existence of the second parliamentary action, and recording, on the computer storage medium, meta-data associated with the second parliamentary action. The method includes creating an electronic record of meeting minutes including the meta-data associated with the first and second parliamentary actions.

According to a further embodiment of the invention, a method of automatically recording video of participants at a meeting includes using a control system to determine locations of meeting participants based on mobile positional indicators, receiving an indication that a meeting participant has been authorized to speak, using the control system to position the camera to focus on the authorized speaker, and recording video of the speaker.

### BRIEF DESCRIPTION OF DRAWINGS

The accompanying drawings are not intended to be drawn to scale. In the to drawings, each identical or nearly identical component that is illustrated in various figures is represented by a like numeral. For purposes of clarity, not every component may be labeled in every drawing. In the drawings:

FIG. 1 is a flow chart illustrating a method of facilitating parliamentary procedure according to one embodiment of the invention;

FIG. 2 is a chart of motions and their attributes for one example of a parliamentary procedure;

FIG. 3 is a table which may be displayed to a user according to one embodiment;

FIG. 4 is one embodiment of a display of available parliamentary actions;

FIG. 5a is an example of meeting minutes created according to one embodiment;

FIG. 5b is an example of meeting minutes created according to another embodiment;

FIG. 6 is a flow chart illustrating a method of creating an electronic record;

FIG. 7 is a flow chart illustrating a method of automatically recording video of a meeting;

FIG. 8 illustrates an exemplary computer system on which some embodiments of the invention may be implemented; and

FIG. 9 illustrates an exemplary networked computer system having components that may be used by some embodiments of the invention to provide automated parliamentary procedures.

### DETAILED DESCRIPTION OF INVENTION

According to embodiments disclosed herein, group decision making rules are converted from a verbal, human readable description into a logical, machine-readable description. Further embodiments disclosed herein include methods and apparatus directed to taking advantage of machine-readable descriptions of group decision making rules. According to one aspect, a network of electronic devices is configured to accept input of parliamentary actions from group members, and a processor and user interface are configured to present group members with dynamic, context-sensitive prompts and tools throughout the progress of a meeting. For example, when a parliamentary action occurs, and the action may be input to a software program, a list all of the available subsequent parliamentary actions is presented to a group member on the group member's laptop or smartphone. The presentation of available parliamentary actions may be supplemented with additional information, such as motion attributes, frequency of use, likelihood of success, etc.

According to another aspect, a processor and a user interface are configured such that a real time recordation and presentation of the progress of a group meeting may be performed. More than simply an electronic recordation of meeting minutes, this recordation and presentation may include metadata, and/or may include context-sensitive information or even recommendations for a user. In some embodiments, video and/or audio recordings may be integrated into the recordation.

In some embodiments, only one or two input and display devices may be used. For example, the chair and the secretary of a group meeting each may have a computer which permits the input of parliamentary actions. When a group member puts forth a motion, or when a vote is taken, the secretary enters the relevant information into a software program, and the information is displayed on a main screen for all group members to view.

In other embodiments, group members may have electronic devices which permit them to input parliamentary actions (such as putting forth a motion) by inputting the actions using the electronic devices. The electronic devices may be networked such that progress is updated in real-time for each group member.

Context-sensitive information may be provided along with the progress of the meeting, whether displayed on a main screen or on individual group members' electronic devices. For example, a group member may have a tablet computer which provides a display of the ten most recent parliamentary actions and a list of parliamentary actions which are available to the user at the present time. In addition to the list of available parliamentary actions, context-sensitive information may be displayed, such as frequency of use of certain parliamentary actions, success rates of certain parliamentary actions, potential subsequent parliamentary actions, profile information regarding the member who put forth the most recent action, and/or other suitable information.

Another type of context-sensitive information which may be presented to a group member during a meeting is information regarding possible reactions of an opponent to the group member's considered parliamentary action. For example suppose member A is considering a motion. In some embodiments, left clicking on “main motion” would input “main motion” to the networked system. But by right clicking on “main motion”, a list of possible responses by an opponent to a motion may be presented. When member A right clicks “motion”, member A may be presented with “motion to table main motion” as a possible reaction by an opponent, Member B. Member A then may prepare for this reaction, for example by gathering data about Member B and being prepared to argue that that the motion to table is dilatory and not constructive, and Member 2 has a track record of making such dilatory motions to slow down the constructive work of the group.

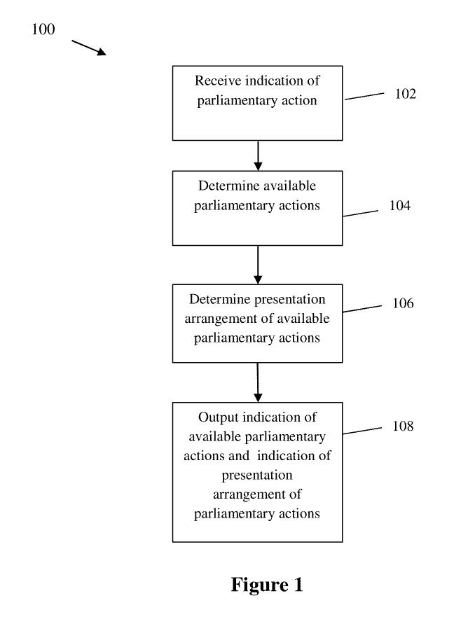

One embodiment of a method 100 of facilitating parliamentary procedure is illustrated in FIG. 1. In an act 102, one or more processors receives an indication of a parliamentary action. This indication may be received in the form of a signal being communicated from a group member's electronic device in some embodiments. In other embodiments, the processor may generate the indication based on voice recognition or other recognition technologies. The particular manner in which the parliamentary action is indicated is not necessarily important in some embodiments.

In an act 104, a processor determines available parliamentary actions, that is, parliamentary actions which would be compliant with the set of rules governing the parliamentary procedure. This determination may be based at least in part on a hierarchical decision making structure as discussed further below in the Hierarchical Organization Section.

A presentation arrangement of the available parliamentary actions may be determined in an act 106. The presentation arrangement may include a list of available parliamentary actions, and the order of the list may be determined in act 106. In some embodiments, act 106 may include determining which of the available options to not display (if any). The presentation arrangement also may include a highlighting of certain parliamentary actions, or the inclusion of associated text boxes with potentially useful information to accompany all or some of the available actions. In short, rather than simply listing the available parliamentary options in a random order or in the same order regardless of the circumstances, a presentation arrangement may be determined based on any of a number of factors, several of which are discussed further below.

In some embodiments, a presentation arrangement is determined by the same processor which determines the available parliamentary actions, while in other embodiments, a client device, such as a group member's own electronic device, determines a presentation arrangement. For example, a central processor may determine which parliamentary actions are compliant based on the current status of the meeting, and output an indication of these actions to a client device being used by a group member. The client device then may determine how to present the actions to the group member, perhaps based at least in part on the group member's personal preferences.

Although a particular presentation arrangement may be beneficial, in some embodiments, an act of determining a presentation arrangement is not performed, and the presentation of available actions is predefined with no adjustments made to account for particular circumstances.

Indications of the available parliamentary actions and a presentation arrangement of the available parliamentary actions are output in an act 108. In some embodiments where a presentation arrangement is not determined, act 108 does not include outputting an indication of a presentation arrangement. However, in some embodiments, a presentation arrangement may be output even if the arrangement was not determined as part of a particular method.

A parliamentary action includes any action undertaken as part of system of a parliamentary procedure that is specified by a parliamentary authority. For example, when using Robert's Rules of Order, a motion or any formal step involved in handling a motion would be considered a parliamentary action. Other actions may be considered a parliamentary action, such as calling a meeting to order for example.

Timeline

In some embodiments, meeting actions are displayed on a timeline, such as a vertical timeline. For example, future meeting agendas may be displayed on a vertical timeline, and meeting minutes from past meetings, including metadata, also may be displayed on a vertical timeline. During an active meeting, the user interface may be beneficial in terms of presenting future parliamentary actions which are available to group members at the present meeting time.

Although many of the aspects of the disclosure herein relate to presenting available future parliamentary actions, by creating well-structured data about available action which can be selected, a practical foundation is created for generating well-structured data about the past and linking that data to other datasets. This linking allows records about the past to be greatly enriched. Information about the past also may be used to structure options for the future because past behavior can be used to forecast the future. Past meetings may take the form of minutes, which may be integrated with audio/video recordings of the meetings as well as links to other data such as member profiles and voting histories.

For example, consider the meetings of the Happy Society, which meets on the second Wednesday of each month at 7:00 pm. The meeting minutes can be displayed in a vertical format with the more recent meetings/actions displayed under the older meeting/actions. The facet next to each item indicates it can be expanded if selected.

>Nov. 11, 2009

>Dec. 9, 2009

>Jan. 13, 2010

>Feb. 10, 2010 (current meeting)>

>Mar. 10, 2010

>Apr. 14, 2010

>May 12, 2010

Future meetings are stored in the form of agendas. Most groups have regularly scheduled future meetings that can be placed on a calendar. Many future agenda items, such as when to nominate and elect officers, are specified in bylaws or minutes. Each meeting starts with an agenda. As the meeting progresses, the line between the past and the future changes, with the agenda in the future and the minutes in the past.

As official actions at a meeting are chosen and tagged with metadata in real-time, an opportunity is created to create a much richer version of a recordation of the past as embodied in minutes. With current minutes-generating technology, minutes typically are offered in only one view: the view prepared by the secretary or another officer of the group. Using methods and apparatus disclosed herein, the content and display of minutes may be more easily separated, with the display under the control of the user in some embodiments.

The methods of selecting parliamentary actions in the present are integrally related to creating minutes which are enriched with metadata and easily searched and accessed because by inserting metadata into minutes in real-time, the cost of adding metadata to minutes is dramatically reduced.

Available Future Actions

Each available parliamentary action presented below the line separating the past from the future may be organized hierarchically by type of potential action. Before a meeting starts, the only available official action may be to “call the meeting to order.” Once the meeting begins, many other options become available based on the recent type(s) of parliamentary action taken.

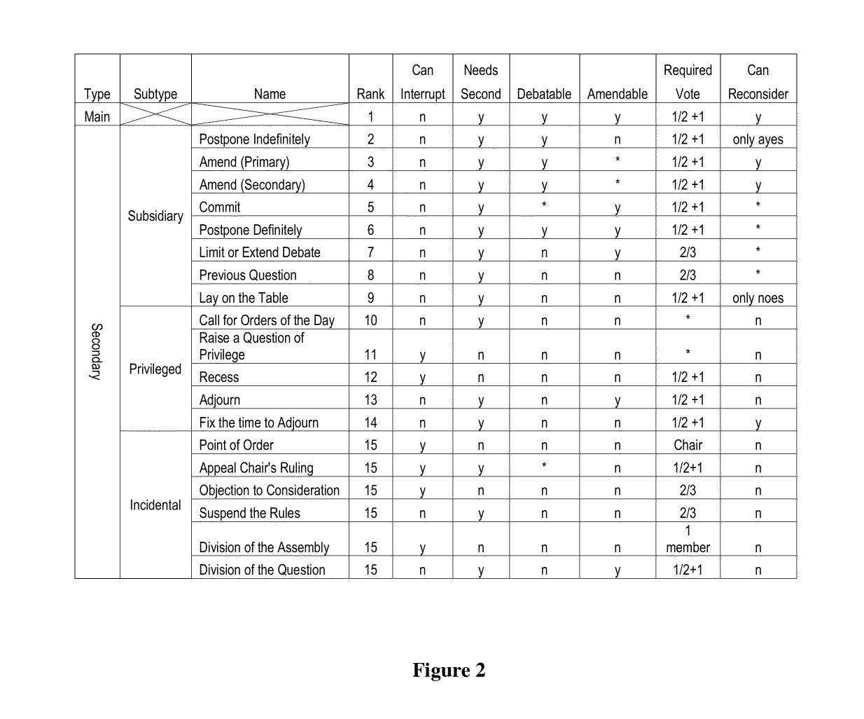

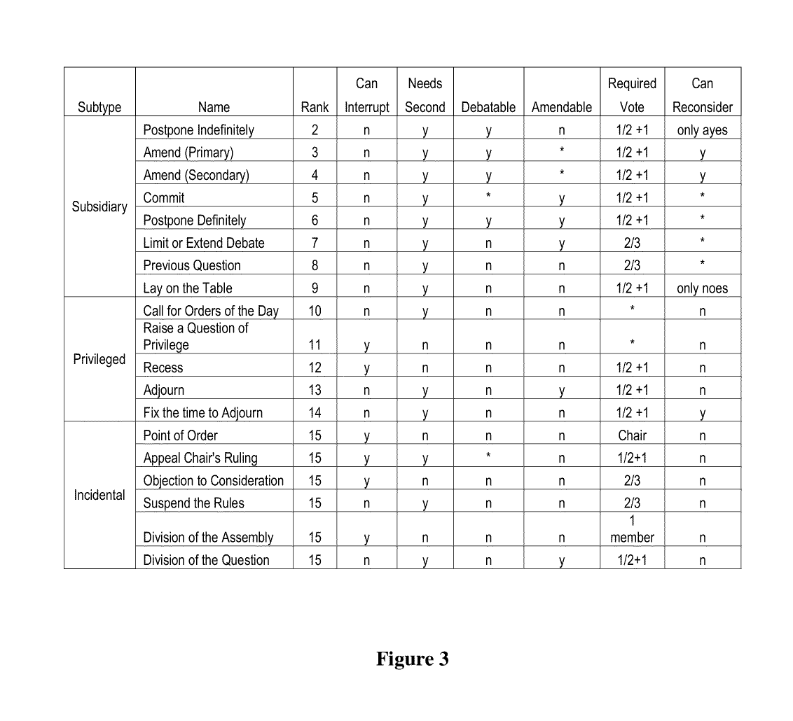

As discussed above, one type of parliamentary action is a motion. FIG. 2 shows a list of motions available using one example of a parliamentary procedure. The list in FIG. 2 includes a main motion. FIG. 3 depicts some of the more widely used motions available after a main motion is made. After a main motion is made, the list of available motions often includes the greatest number of motion options because any motion with a rank of greater than 2 can be made. In many parliamentary procedures, each motion includes seven attributes, including: its rank, whether a speaker can be interrupted to introduce it, whether it needs a second, whether it is debatable, whether it is debatable, the required vote for it to pass, and whether it can be reconsidered. The display of these attributes may be suppressed depending on each user's preferences.

Presentation of Available Actions

Available parliamentary actions may be presented to a user via a simple chart of available parliamentary actions, such as the chart shown in FIG. 3. Other manners of depicting hierarchically organized choices may be used, such as facetted searches, drop down menus, outlines, and combinations thereof. A wizard may combine a comprehensive series of such hierarchical choices into a single interface. Instead of a user indicating a parliamentary action by selecting from among a displayed list of available parliamentary actions, an action may be entered in a text entry box. In some embodiments, a search line may be provided, and the program may support automatic to text completion, including a list of alternatives for text completion.

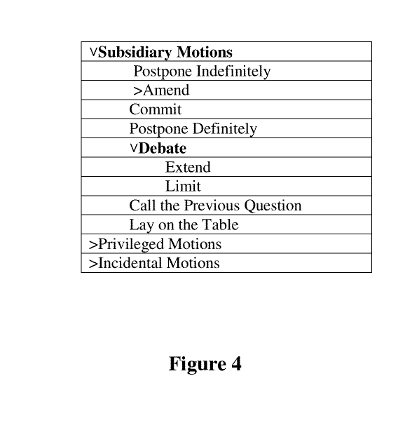

FIG. 4 shows one embodiment of a display of available parliamentary actions. In this example, the displayed actions are motions, and the motions are displayed in an outline. The outline allows for a facetted search, and the facets which have been selected by a user are shown in bold.

The display of available parliamentary actions, such as motions, based on whether they are allowed may be used to provide only a comprehensive display of available options. In some embodiments, however, the number of actions may be reduced, or additional information may be provided for some or all of the actions based on the likelihood that particular action will be selected, a user's goals, and/or other criteria based on a user's preferences or a group's preferences.

One criterion which may be used to determine how or whether to display a certain available parliamentary action is past behavior. For example, the likelihood of each potential future action, based on a model which takes past behavior into consideration, may determine the order in which available actions are listed and which action is the default action. Only the most likely actions may be displayed as a default on the screen, with additional actions or a complete list of actions only called up with an additional user selection. The user, or an interface template which the user selects, may control all or some of the aspects of the display, such as how many actions or what type of threshold of likelihood should be used in the default display of actions. For example, a user may request that the most likely action be displayed, combined with a button to display other available actions. In this example, after a main motion is introduced, the secondary motion most likely to be introduced may be an amendment, and an amendment option will be presented to the user. If the user wishes to see other available actions, the user may click on the button.

Another criterion on which a presentation arrangement may be based is explicit goals of a user. At any particular point in a meeting, a user may have goals that tend to restrict the number of available actions that would interest him or her. The user may be given a list of goals from which to choose one or more goals in some embodiments. Each goal may have associated with it a list of parliamentary actions. Shown below is a list of goals, with associated parliamentary actions listed after each goal. Depending on which motions are currently on the floor in a meeting, some of these options may not be available and may be dimmed, struck through, or otherwise indicated as not available or not desirable.
Improve a pending motion
   Amend
   Division of Question
Regulate debate
   Limit Debate
Extend Debate
   Close Debate
Delay a decision
   Commit (Refer) to Committee
   Postpone Indefinitely
   Postpone Definitely (Temporarily)
   Recess
Suppress a proposal
   Table
   Withdraw a Motion
Gain information on a pending question
   Parliamentary Inquiry
   Request for Information
   Request to Ask Member a Question
   Raise a Question of Privilege

Inferred goals may be used as a criterion by which a presentation arrangement is determined. Instead of having the user explicitly identify his or her goal(s), the software program may infer his or her goal (or goals) and display available actions accordingly. For example, if two participants at a meeting almost always oppose each other's motions (e.g., because one is an extreme conservative and the other is an extreme liberal), then if one of the two participants introduces or seconds a motion, this could lead the software program to infer that the other participant will want to oppose the motion. The other participant's device could then highlight all of the available motions to kill or delay the motion. Alternately, when each user tentatively enters his or her vote on the motion on the table, the computer may highlight alternative means to a no vote (such as tabling the motion or referring it to committee for further study) to reduce the odds of the motion passing.

To help infer user goals, various techniques may be combined. For example, if a search box is used for the user to generate desired options, search results may be based on a model of the user's past behavior, other users' past behavior, and the logical implications of the user's current query.

Another option for determining how or whether to display various available actions is an action attribute filter. Each of the attributes of a motion, such as whether it is debatable or needs a second, may be used to filter and sort the list of available motions.

A context-sensitive help system may provide both a literal and strategic definition of each parliamentary option. The literal definition describes the ostensible purpose of a motion. The strategic definition describes what considerations might influence the use of the motion, including what motions may be close substitutes. For example, when one wants to vote “no” on a motion, close substitutes are to table or indefinitely postpone consideration of the motion. In contrast, when one wants to vote “yes,” tabling and indefinitely postponing are not close substitutes. In a literal definition of table a motion, this motion would postpone for further consideration, not kill or defeat, a motion. But strategically, it can be used in other ways, such as a polite way to say no or to wait and mobilize allies to defeat the motion at a future meeting. Because there is flexibility and often substantial moral disagreement in providing strategic as opposed to literal definitions of a parliamentary option, a user may want to select the type of strategic definitions offered as part of a set of preferences.

A set of steps for handling each motion may be presented with each motion. These steps may also be hierarchically organized in some embodiments. For example, consider a typical sequence of steps associated with the successful introduction of a main motion without the introduction of any secondary motions.

1. Member X: Rises and addresses the Chair

2. Chair: Recognizes member X

3. Member X: Proposes a motion

4. Member Y: Seconds the motion

5. Chair: States the motion

6. Members: Debate the motion

7. Chair: States the motion and calls for vote

8. Members: Vote

9. Chair: Announces result

This sequence of steps may be altered depending on the official actions of meeting participants. For example, if no second is made in step 4, the motion fails, or if a secondary motion is introduced during step 6, a new series of steps may be displayed.

Linked to each parliamentary action, including motions and steps to handle motions, may be a template which includes standardized phrases and algorithms. Filling out a template to execute an official action may be automated or semi-automated. Once an official action is made, the associated template may pop-up automatically or be selected. Some templates, such as a template for a motion to call the preceding question, may be completely prefilled. Others, such as to amend a particular motion on the floor, may require the user to fill in one or more fields. To complete a field, the user may type an entry in the field. Alternatively, the user may complete a field by selecting an entry for the field by choosing from a list or set of possible entries, for example a drop-down menu.

For example, presented below is a sequence of templates to introduce and then vote on a main motion.

1st member: Mr. Chair (pause to be recognized), I move that we (state the motion).

2nd Member: I second the motion.

Chair: It is moved and seconded that we (state the motion). Is there any discussion?

Seeing none, the motion will be put to a vote. The vote is on the motion that we (state the motion). Those in favor say ‘aye.’ Those opposed say ‘no’. The aye vote is (state the vote). The ayes have it, and the motion is carried. Is there any further business?

Note that some of the templates require that fields be completed, while other field are already completed. It should also be noted that the options in the template for a particular official action may be hierarchically organized; that is, the options may be based on a certain sequence of preceding actions. For example, if the “noes” have the greatest number of votes, the “aye” clause above would be substituted with: “The ‘No’ vote (state the vote). The noes have it, and the motion is defeated. Is there any further business?”

Another type of template automation is directed to motions to amend the wording of another motion. Three ways to amend a motion exist: adding words or phrases, striking out words or phrases, and substituting by either striking out and inserting words or substituting an entire motion or paragraph. One way to amend a motion is to do so directly on the text of the motion and then have those changes automatically translated into standard parliamentary procedure. For example, instead of inputting, “Mr. Chair, I move that we amend the motion by appending the words ‘for use at our future meetings,’” the member could simply input into a template, “for use at our future meetings” after “I move that we acquire software to automate parliamentary procedure.” The template could then automatically translate the insertion into the parliamentary speak, “Mr. Chair, I move that we amend the motion by appending the words ‘for use at our future meetings.’”

Template automation also may involve incorporating data external to the meeting. For example, a template for a motion to adjourn may automatically include the date of the next meeting if it is regularly scheduled or has otherwise been decided upon. Having this time field completed can be important because the presence of a time or lack thereof determines the rank of a motion to adjourn and thus the next set of feasible motions. A motion to adjourn is only privileged if a time has been specified for the next meeting because breaking up a meeting without specifying a next meeting effectively dissolves the group according to some parliamentary procedures.

Another type of template automation involves different styles of language for the same motion. For example, a meeting participant sensitive to gender issues might discard the template: “Mr. Chairman, I rise to a point of order (state the point of order)” and replace it with: “Mr. Chairperson, I rise to a point of order (state the point of order).”

Meeting Minutes

As the present recedes into the past, agendas are transformed into minutes. For example, consider the Feb. 10, 2010 meeting agenda for the Happy Society:

Happy Society Meeting Agenda—Feb. 10, 2010

Call to order: 7:00 pm

Approval or correction of minutes

Reports of officers

Reports of committees

New business

Announcements

Adjourn

With conventional meeting procedures, agendas are transformed into a largely unstructured set of minutes. For example:
Happy Society Meeting Minutes—Feb. 10, 2010
The regular monthly meeting of the Happy Society was called to order at 7:05 pm on Feb. 10, 2010 at the Society's Office.
The minutes of the Jan. 13, 2010 meeting were approved as corrected.
Treasurer Joe Smith reported that the Society had $5,001 in cash.
Happiness Indicators Committee Chair, John Grump, reported on the latest scholarly research on happiness indicators.
Happiness President Dick Happy moved that the Happiness Society use an automated parliamentarian software program beginning at the regularly scheduled April meeting. The motion passed.
President Happy announced the next meeting would be on Apr. 7, 2010, at 7:00 pm., and declared the meeting adjourned at 9:01 pm.

Using embodiments disclosed herein, the minutes may be generated in real-time and in a well-structured format, which leads to more efficient and effective groups. Real-time access means that instead of waiting for a secretary to write minutes after a to meeting and then waiting for the minutes to be approved and posted at the next meeting, which may be months later, the user may access the minutes as soon as the official act to which they refer occurs.

Well-structured access means that the user of the minutes may read the minutes in any level of detail desired. The user, for example, may exclude debates, seconds, and the details of votes. The user also may control the style in which the official actions are presented in words. For example, motions are typically presented in present tense but usually translated into past tense for minutes. The user may choose to view the minutes in either the present tense or past tense.

We may categorize minutes by their degree of structure. With minimal structure, minutes look much the way they do today: unstructured text with no metadata. Toward the other end of the spectrum, minutes are highly structured and have a display flexibility based on the metadata that has been embodied in them, largely in real-time as the meeting has progressed.

To save screen space and focus only on only those aspects of the past of current use, the past portion of a meeting may be completely or partially hidden from view.

A simple way to structure a past view of minutes is to break up the minutes using the headings contained in the agenda for the meeting. For easy access to earlier parts of a meeting, the user may collapse or expand the minutes based on each agenda item. This principle of expandable vs. collapsible meeting information may be extended to other portions of the meeting minutes.

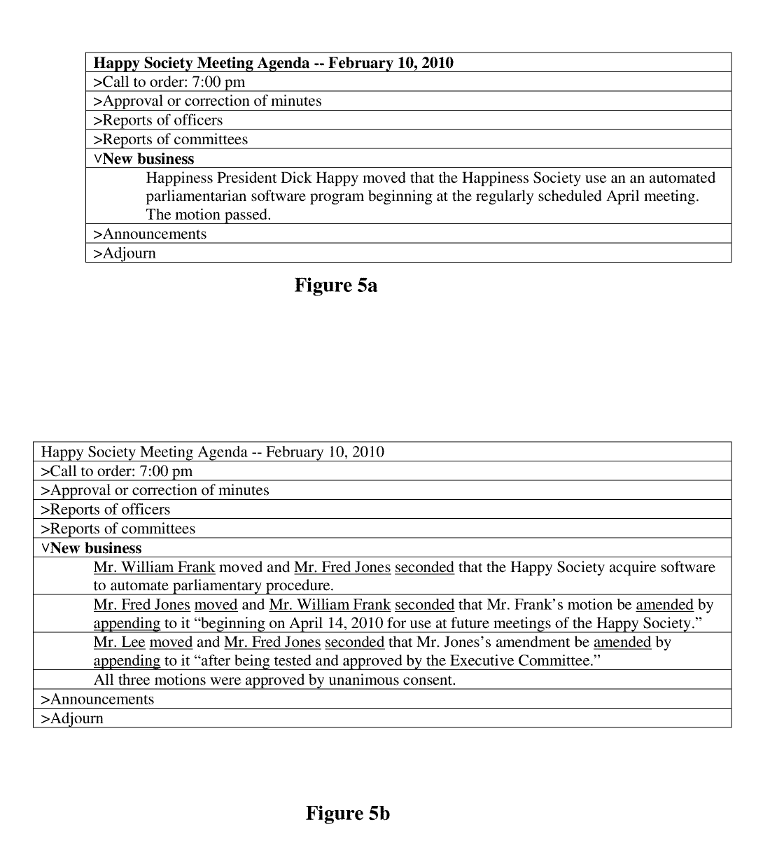

FIG. 5a depicts minutes with a minimal level of structure, relying on an agenda prepared before the meeting to provide that structure.

When official actions are tagged with metadata and included in the minutes, a complete record may be explored. FIG. 5b depicts minutes based on a complete record of tagged official actions.

Each link (underlined text) may be clicked to bring up additional information. A left click may bring up a default link and a right click may bring up a menu of links. A default link on a meeting participant, for example, might include a link to the participant's official biographical profile. A right click on a participant might bring up a menu of options such as the participant's voting history, potential conflicts of interest, influencers (e.g., officials and other opinion leaders who the participant tends to vote with), and voting blocs (e.g., other participants who tend to vote with or opposed to the participant). Much of this data may be external to parliamentary procedure but made useful in real-time when the data is automatically integrated with parliamentary procedure.

Minutes based on the comprehensive collection and tagging of parliamentary actions may be displayed in many different ways, such as displaying only main motions, or main motions that won, or main motions with roll call votes as opposed to, say, unanimous consent, or main motions or secondary motions that were controversial (e.g., where the number of ayes and noes were close).

Collapsible minutes of many past meetings, including meetings of committees and subcommittees of a group, also may be combined in a simple display. Because the minutes of many previous minutes may be useful to analyzing a current motion on the floor, this combination can be useful. For example, some groups require a new bill or policy to be read three times over three different meetings. On the third reading, it may be useful to have immediate access to the two previous readings.

As discussed herein, metadata may be stored in association with parliamentary actions. Every motion in the text may be tagged with metadata that describe the type of motion; every vote may be tagged with metadata that describe the type of vote; and every speaker may be tagged with metadata that describes the type of speaker. Each piece of data may be tagged with more than one type of metadata. For example, in addition to the type of motion made, metadata may describe the time the motion was made.

In some embodiments, each official action, including the metadata associated with each action, may be time stamped and indexed to an audio and/or video record of the meeting. Such an arrangement permits efficient searching of audio and video records. For example, if a user wishes to search for video all the instances where the chair was out of order, it would be straightforward to search the electronic record of the meeting for instances of the chair being out of order, and the associated timestamp and indexing would allow for quick viewing of the associated video.

With embodiments disclosed herein providing an easily searchable and sortable structure of meetings, minutes also may be displayed as statistical summaries. For example, it may be useful to see who typically votes with whom so that the opinion leaders and coalitions in a group may be easily identified. If roll call votes are used to record votes on motions, this type of statistical analysis becomes straightforward. This type of analysis may include integration with external databases and sophisticated analytics, such as motions that lost in the order they were introduced but would have won if introduced in a different order.

A simple but potent benefit of a hierarchical view is that it makes it easy to understand which main motion and secondary motions are currently on the floor. Keeping track of the motions currently on the floor can become confusing for audience members and may result in a skilled and alert chair having to constantly remind members of all the different motions on the floor. These reminders empower members but at the cost of slowing down the meeting. With a hierarchical, real-time view of the decisions currently on the floor, members can quickly see a visual or textual representation of the structure of the decision currently on the floor. Members can thus be empowered without slowing down the meeting.

The list below depicts the structure of a set of motions currently on the floor:

| | |
|---|---|
| 1. | Main motion: Acquire software to automate parliamentary procedure |

| | |
|---|---|
| 2. | Primary Amendment: For use at our future meetings |

| | |
|---|---|
| 3. | Secondary Amendment: After being tested and approved by |

the Executive

Committee

| | |
|---|---|
| 4. | Refer to executive committee [defeated] |

| | |
|---|---|
| 5. | Close debate [passed] |

| | |
|---|---|
| 6. | Table [defeated] |

| | |
|---|---|
| 7. | Vote on Secondary Amendment [passed] |

| | |
|---|---|
| 8. | Vote on Primary Amendment [passed] |

| | |
|---|---|
| 9. | Vote on Main Motion [the pending action] |

Another feature of minutes is the degree to which they summarize the past and leave out detail. In part because minutes are burdensome to both prepare and read, they are typically only a summary of the most important official actions that have taken place at a meeting. For example, the detailed sequence of introducing and voting on amendments is often excluded, instead just including the vote on the final version of the main motion. A lot of the information currently excluded is arguably important to the transparency and accountability of a representative group. If the information can be to efficiently gathered in real-time—as can be done with an automated parliamentarian—but excluded from view when desired, the most popular current excuses for not to keeping the information as part of the official record of a meeting are eliminated.

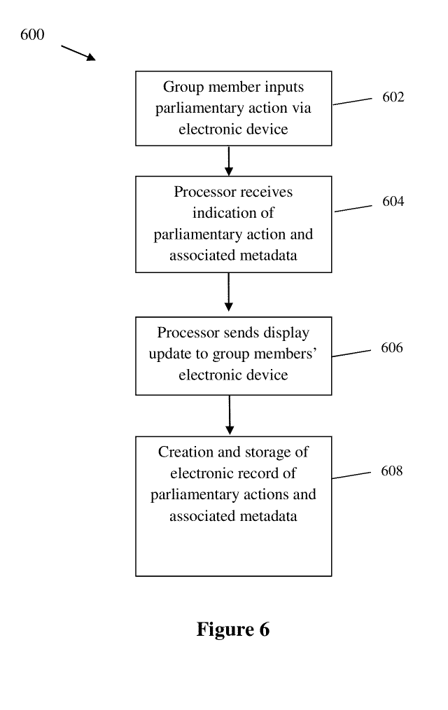

One embodiment of a method of creating a recordation of a meeting and updating meeting minutes in real-time is shown in FIG. 6. In an act 602, one or more group members inputs a parliamentary action via an electronic device. For example, each group member may have a laptop or other device into which he or she enters motions. A processor receives an indication of the parliamentary action and associated metadata in an act 604. For example, the processor may receive an indication of the identity of the group member, the time the motion was input, etc. In some embodiments, the processor generates the metadata, but this would be considered receiving the metadata for purposes herein.

So that group members may track and review a meeting's progress in real-time, the processor sends a display update to the group members' electronic devices in an act 606. In some embodiments, the display update comprises the new information to be displayed on the member's electronic device. In some embodiments, the display update is a notification to each electronic device that an update has occurred, and the electronic device should retrieve the information from a specified source.

An electronic record is created and stored in an act 608. Metadata may be stored within the electronic record. As discussed herein, to simplify record displays, displays of the electronic record may be adjustable such that certain information or metadata is hidden by default, but can be viewed on request.

Hierarchical Organization

In some parliamentary procedures, a decision making structure may be hierarchically organized into a decision tree. In other words, at any given point in a meeting, the next type of official action is not equally likely. Some decision making nodes may be determined by the structure of formal decision making rules. For example, an amendment cannot be made until a main motion is on the table. Others may be probabilistic, based on some type of past behavior or member intent. For example, if a chair of a public body has most often called for a particular type of vote (e.g., a voice vote) when a vote on a motion initially comes up, it can be predicted that the next time a motion comes up, the chair will most likely call for a voice vote. Similarly, if the chair has next most frequently called for a show of hands, it can be predicted that the next time a motion comes up, the chair will next most likely call for a show of hands. Of course, such predictions, like a web search engine search result, may take advantage of many different variables. In certain embodiments, context-sensitive information related to the hierarchical organization of a decision making structure may be provided to a group.

It should be noted that if all members of a decision making body have access to a suitable interactive electronic device such as a laptop, smartphone, or audience response clicker, the hierarchical nature of a group meeting ontology can be better exploited. If only a few members of a group have access to such devices, it may be viewed as unfair to other group members, and thus damaging to the group, to use them.

The hierarchical structure of group decision making rules is discussed below. For illustration purposes only, the hierarchical structure is drawn from Robert's Rules of Order.

Motions may be divided into two main categories: main motions and secondary motions. The main motion is the main proposal that the group is working on. An example: “I move that this body adopt an automated parliamentarian for use at its future meetings.”

A secondary motion is one that can be made while the main motion is on the floor. An example: “I move to amend the main motion by appending to it: ‘and that is compatible with our bylaws.’”

Each type of motion has a rank that can be depicted hierarchically. No motion can be introduced at a point in the meeting when the preceding motion is of a higher rank. For example, secondary motions have a higher rank than main motions. Consequently, a secondary motion, such as to amend a main motion, cannot be introduced until there is a main motion already on the floor.

There are three types of secondary motions: Subsidiary, privileged, and incidental. Incidental motions have higher rank than privileged motions, which have higher rank than subsidiary motions. Subsidiary motions apply to the main motion. For example, “I move to postpone discussion of adopting an automated parliamentarian until this group has seen a demonstration.”

Privileged motions relate to the welfare of the group and are of such importance to the group that they must be acted upon immediately. An example is a motion to to adjourn: “After three hours of meeting without a break, I move we recess for fifteen minutes.”

Incidental motions relate to the procedures governing the disposition of a current issue on the floor and must be addressed before those issues can be disposed of. An example is a point of order: “I rise to a point of order: the speaker's microphone is too low; we cannot hear him in the back of the room.”

Subsidiary, incidental, and privileged motions are broad categories of motions that are collections of other motions, each of which has a hierarchical rank.

Each type of secondary motion may have many subcategories, each in turn given a distinct rank. For example, subsidiary motions include call the previous question, amend, commit, postpone, and debate. These subcategories may each have subcategories. For example, “postpone” may be divided into “postpone indefinitely” or “postpone to a future time.”

FIG. 2 depicts the hierarchy of motions, along with some of their most important attributes. Note that incidental motions all have the same rank. This is because an incidental motion must be immediately disposed of; that is, before any other motion may be introduced.

A total of seven motions, organized hierarchically, may be before the group at any one time. The list below illustrates a main motion with multiple secondary motions on the floor. The hierarchy of the motions is reflected by the number of each line and the indents. Next to each motion is its status in brackets, defeated or won.

| | |
|---|---|
| 1. | Main motion: Acquire software to automate parliamentary procedure |
| | [won] |

| | |
|---|---|
| 2. | Primary amendment: For use at our future meetings [won] |

| | |
|---|---|
| 3. | Secondary amendment: After being tested and approved by |

the Executive Committee [won]

| | |
|---|---|
| 4. | Refer to executive committee [defeated] |

| | |
|---|---|
| 5. | Close debate [won] |

| | |
|---|---|
| 6. | Table [defeated] |

The hierarchical relationship among rules may be quite subtle. Consider a nominating committee that proposes a slate of candidates, which the chair asks the members to vote upon. Often the slate will be unanimously approved by the members. If the slate is not unanimously approved, a separate vote must be taken on each office to be filled. In other words, if a slate had 99% of the vote, it would still be inadequate to win, so the difference between 100% and 99% changes the options that are available.

Ratings

Participant ratings of motions or other actions made during the course of a meeting may be incorporated in embodiments described herein. For example, when a participant proposes a motion, group members may be able to rate the motion. The rating may be binary, such as answering the question, “Is this motion constructive?”, or may be numerical or include a number of choices from descriptors. A rating system also may be implemented for comments made by participants. For example, a rating of comments may be a yes or no answer to a question such as, “Does this comment contribute important information to the group's current discussion?”

The methods and apparatus disclosed herein can bring greater efficiency, fairness, and effectiveness to group decision making. Several potential benefits are described below, though various embodiments may include one, several, or none of the below benefits, and of course may include additional benefits.

Automated Context-Sensitive Help

If provided with context-sensitive help as the meeting proceeds, group members and officers (such as the meeting secretary, parliamentarian, and chair) can learn parliamentary rules much more rapidly. Regarding the audience, context-sensitive help may permit audience members to: understand whether a motion which they would like put forward is in order before making the motion, see what motions may be made at any particular point in a meeting, including at the current point in time, and receive detailed, context-sensitive help about the reasons to use a particular motion and why motions are structured the way they are (e.g., why some motions require supermajorities while others require simple majorities).

Automated Creation of Minutes

Secretaries, who create group meeting records, can create meeting minutes with greater ease using embodiments disclosed herein. Secretaries can quickly see the present status of a meeting and understand what the group's likely next steps may be. To the extent that audience members and the chair electronically enter their official actions, the role of the secretary would be made even easier. Embodiments of the invention facilitate the creation of both traditional minutes finalized after a meeting and the creation of automated minutes created in real-time as the meeting proceeds. Many groups find it difficult to find skilled and unbiased group members willing to serve as secretary. Difficulty in finding appropriate secretaries may not only harm the operation of a group but prevent a group from forming altogether.

Difficulty in finding volunteer secretaries has contributed to the widespread practice of using secretaries that work for the organization that the group seeks to make accountable. This creates an inherent conflict of interest in a secretary's reporting. For example, with quasi-government groups such as government advisory bodies, difficulty in finding competent volunteer secretaries can often result in a government employee taking over the position of secretary even when the employee represents a government entity directly affected by the group's official actions. In such cases, the secretary may be the highest paid group officer and the primary administrative expense of the group.

Automated Time-Based Linkages Between Minutes and Audio/Video Meeting Recordings with Automated Transcriptions

When meeting minutes are created in real-time, the cost of creating time-based linkages between minutes and the high fidelity but unstructured audio/video recordings of meetings (plus the automated transcriptions of such recordings) can be greatly reduced or even eliminated. These time-based linkages, in turn, facilitates convenient and sophisticated searching of meeting records. Viewers, for example, can instantly search for discussions of issues that were controversial, for example by searching for instances where the yay and nay votes were close.

Reduced Delay Between a Meeting and the Publication of its Minutes

Automating minutes so they can be created in real-time eliminates the delay between when a meeting takes place and when minutes of a meeting are approved and made publicly available. This delay can be many months or even years for bodies that infrequently meet. In between, meeting participants are likely to forget the exact contents of the meeting or may not attend the subsequent meeting when the minutes are approved. Those writing the minutes may have strong incentives to exploit the delay to bias the minutes in ways members and others find hard to detect. Consequently, automating the production of minutes may greatly reduce the production of biased minutes. Delay in the production of minutes also harms the accountability of group participants and leaders, as reporters and group members who missed the meeting may not have a practical alternative for timely access to meeting information. Typically, the greater the delay between a meeting and the production of public records of the meeting, the less value those records have for fostering accountable group decision making.

Automated Validation of Parliamentary Procedure.

If parliamentary procedure can be reduced to a machine-readable logic, then violations of parliamentary procedure (e.g., being “out of order”) can be automatically detected and thus prevented. Illegal yet common overrides of parliamentary procedure, such as ignoring a quorum requirement included in an organization's bylaws, would be less frequent because such overrides would require more transparent abuses and require more meeting participants to explicitly permit the abuse. In some embodiments, a violation of procedure may not be entered into the official record of the meeting without at least some type of warning and override consented to by group members and officers. Not all types of violations of order are subject to machine readability and thus automation. For example, a decision as to whether a comment is insulting and therefore out of order would still be left to the chair. But detections of violations of the well-structured components of parliamentary procedure could be automated.

Greater Complexity of Parliamentary Procedure

Although many types of parliamentary procedure are viewed as already being complex, the complexity, and therefore the utility, of parliamentary procedures is often limited because of the difficulty of users learning and using the rules of the procedure. This limitation has resulted in great pressure to create excessively simplistic and often inappropriate versions of parliamentary authorities. With the new technology to learn and apply parliamentary procedure, more complexity becomes feasible. For example, to prevent member confusion, only primary and secondary amendments are allowed to a main motion. But if members could easily keep track of the motions on the floor, tertiary and more complex amendment structures may become more practical. Similarly, the requirement to use seconds to introduce certain motions could be refined based on context, such as the number of people participating in a group.

Automated Validation of Meeting Records

Secretaries currently take many shortcuts and make many mistakes in recording minutes. For example, secretaries often include only a subset of official actions taken at a meeting. Or they may write down the wording of a motion slightly incorrectly. If all members of the group, including the chair, can see the minutes as they are created in real-time, these types of errors would be more likely to be detected and corrected. In other words, automating the production of minutes also facilitates the production of valid minutes.

Automated Meeting Records Search

Facilitating standardized, well-structured meeting minutes facilitates subsequent meeting records searches, which enhances the dissemination of meeting information and accountability. Note that meeting records are more comprehensive than meeting minutes because they may include other meeting related documents such as audio/video meeting recordings, meeting transcripts, meeting notices, and links to documents voted on at a meeting.

Elimination of the Need for a Group Parliamentarian and Secretary

With certain embodiments, automation may eliminate the need for a group parliamentarian and secretary, or at least reduce the burden of their roles.

Eliminating, or at least reducing, the need for a secretary would reduce group organizational costs. It would also reduce the propensity of secretaries, sometimes individuals with an inherent conflict-of-interest in recording a group's official actions, from creating biased minutes.

Certain technological and procedural aspects provide for the reduction of the need for a secretary. For example, if each meeting member uses an interactive electronic device such as a laptop or smartphone, roll call votes and motions may be instantly recorded, along with unedited audio and video recordings of meetings. Electronically “raising a hand,” that is, inputting into an interactive electronic the desire to speak, and being called on electronically by the chair, can reduce some of the official actions that the secretary needs to record as they could be automatically recorded. Of course electronically raising hands and being called on does not preclude the simultaneous physical raising and calling of hands.

The two lists below compare the order of a meeting as between a conventional meeting and a meeting using an automated parliamentarian.

Order of a Simple Meeting with a Secretary

Chair creates a meeting agenda

Secretary publicly posts the meeting agenda

Chair calls a meeting to order and follows the meeting agenda

Secretary records each agenda item as it is introduced

Chair recognizes various group members in the audience

Secretary records each member so recognized

Audience member introduces motions

Secretary records each motion

Chair calls for a vote on the previous motion and audience members vote

Secretary records the vote

Chair adjourns the meeting with audience member approval

Secretary publicly posts the meeting record

Group members can access the meeting record

Order of a Simple Meeting with the Secretary's Role Automated

Chair creates a meeting agenda

Chair calls a meeting to order and follows the meeting agenda

Chair recognizes various group members in the audience

Audience member introduces motions

Chair calls for a vote on the previous motion and audience members vote

Chair adjourns the meeting with audience member approval

Group members can access the meeting record

The case for eliminating or reducing the need for parliamentarian is similar to the case for eliminating or reducing the need for a secretary. Parliamentarians are often attorneys, and sometimes government attorneys that cost taxpayers substantial amounts to be present at meetings. Often the parliamentarians will provide advice only if asked to, regardless of whether a parliamentary action is out of order. Indeed, a parliamentarian may view it as impolitic to suggest, especially in public, that a meeting participant, such as a school board chair, who directly or indirectly pays their wages, is out of order. If parliamentarian skills are widely distributed in a group and readily available online, then the need for a person specialized in parliamentary procedure is reduced. This could substantially reduce group organizational costs.

Automated Camera System

In some embodiments, automation of the broadcasting and/or recording of a meeting may be facilitated with a camera system that is able to locate speakers within the meeting room. While such a system may be particularly useful in a meeting conducted according to a parliamentary procedure, such a system may be used in other meeting settings as well, such as at conference events or think tank events, or any suitable event where an individual's location can be identified.

According to one embodiment of an automated camera system, participants maintain a mobile positional indicator, and a camera system scans meeting rooms for the participants' mobile positional indicators and stores their locations. When a participant is granted the floor, a camera focuses on the participant using the stored location information.

Mobile Positional Indicator

The mobile positional indicator may be a wireless indicator, such as an RFID tag. In such an embodiment, a passive or an active RFID tag may be used. Of course, other suitable wireless indicators may be used. The wireless indicator may be attached or embedded in a nametag that is provided to the participant before the meeting.

A biometric positional indicator may be used as a mobile positional indicator in some embodiments. For example, a meeting participant may create an electronic profile that includes a facial profile (or other biometric indicator) such that a camera system can use facial recognition software to locate the participant.

A combination of a wireless positional indicator and a biometric indicator may be used in some embodiments. For example, in one embodiment a meeting participant creates a profile including a facial profile or other visible biometric indicator which is then linked to his or her name. The participant signs in to the meeting with his or her profile and is provided with an RFID tag or other wireless positional indicator. The participant links the wireless positional indicator with his or her profile, in some embodiments by explicitly associating his or her name with a unique identifier of the wireless positional indicator, or with his or her biometric profile, and registering this association in a database. The wireless positional indicator may be used by the camera system to identify the general area where the meeting participant is located, and the biometric indicator may be used to guide a more precise close-up view.

Scanning and Location Identification

The camera system may periodically scan the meeting room to associate each participant's mobile positional indicator with a camera position. In some embodiments, when a participant physically raises his or her hand, the camera system may visually scan the meeting room for a raised hand, and once recognized, the system may use facial recognition software to recognize who the participant is.

Camera Control

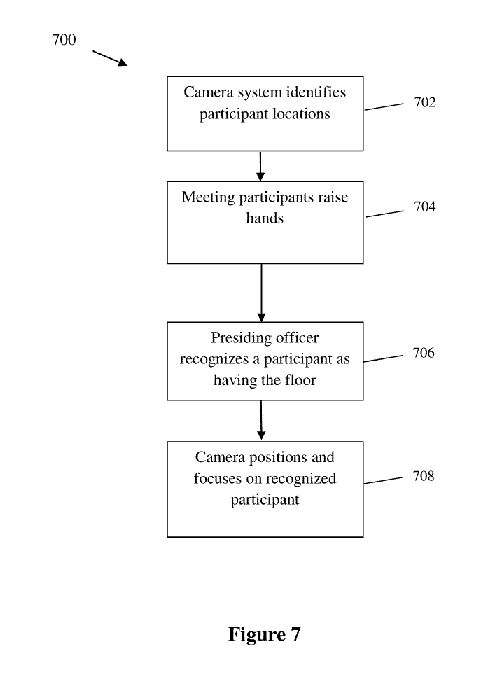

The camera may position itself to focus on a participant who has been granted the floor. For example, in a method 700, as shown in FIG. 7, a camera system identifies the locations of meeting participants in an act 702 as discussed above. The identified location may be a precise location, or it may be a general location which may be refined at a later time. In an act 704, meeting participants raise their hands to be recognized by a presiding officer. The presiding officer also may recognize himself or herself or any speaker on the agenda who is scheduled to speak. Participants may physically raise their hands or virtually raise their hands by indicating a desire to be recognized via an input on an electronic device. In an act 706, the presiding officer recognizes a meeting participant as having the floor. A camera positions itself to focus on the recognized participant using the location identification from act 702.

In some embodiments, a camera system may use a general location identification from act 702 to position the camera, and then a facial recognition system may be used to identify a particular meeting participant within the identified general location.

In situations where the presiding office recognizes more than one participant at the same time, the camera system may be programmed to focus on a minimum area which includes all of the recognized individuals.

According to some embodiments, the presiding officer may grant the recognized meeting participant not only the floor to speak but also control of what the camera covering the floor shows. For example, the recognized meeting participant may have the camera cover himself giving a presentation and/or the media used in his presentation. The participant also may choose the degree of zoom used (e.g., headshot or full body shot) and shot sequence (e.g., full body shot zooming into a head shot).

Privacy Considerations

Meeting participants may be provided with privacy controls regarding aspects of an automated camera system. Regarding profile privacy, the meeting participant may control the length of time the camera system is permitted to retain all or parts of the meeting participant's profile. For example, the meeting participant may stipulate that facial profile information cannot be stored after the end of the current meeting and that the profile cannot be used for anything other than its intended purpose, such as to help a camera focus on the individual at a particular meeting. Regarding the camera image, if the meeting participant does not wish to be seen on camera, a substitute image from his or her profile can be shown instead, subject to the approval of the presiding officer.

Implementation of Aspects of the Invention

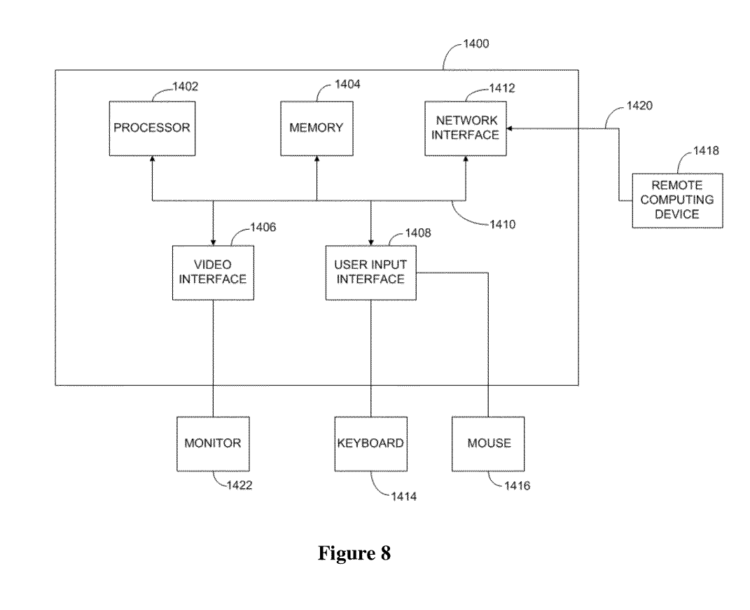

FIG. 8 shows a schematic block diagram of an illustrative computer 1400 on which aspects of the invention may be implemented. Only illustrative portions of the computer 1400 are identified for purposes of clarity and not to limit aspects of the invention in any way. For example, the computer 1400 may include one or more additional volatile or non-volatile memories, one or more additional processors, any other user input devices, and any suitable software or other instructions that may be executed by the computer 1400 so as to perform the function described herein.

In the illustrative embodiment, the computer 1400 includes a system bus 1410, to allow communication between a central processing unit 1402, a memory 1404, a video interface 1406, a user input interface 1408, and a network interface 1412. The network interface 1412 may be connected via network connection 1420 to at least one remote computing device 1418. Peripherals such as a monitor 1422, a keyboard 1414, and a mouse 1416, in addition to other user input/output devices may also be included in the computer system, as the invention is not limited in this respect.

In some embodiments, one or more techniques for performing a covered action search and/or a semantic search as disclosed herein may be performed by one or more processors included in the same or different computer including, but not limited to, computer 1400. For example, the method illustrated in FIG. 1 for facilitating parliamentary procedure may be executed on a different processor than the technique illustrated in FIG. 4 for creating electronic records. Additionally, in embodiments where multiple processors are used, the results of one technique performed by a first processor may be transmitted to a second processor to perform a second technique in any suitable way including, but not limited to, transmitting the results across a wired or wireless network, storing the results in a shared database, and physically transferring the results to a second computer on a tangible computer-readable medium.

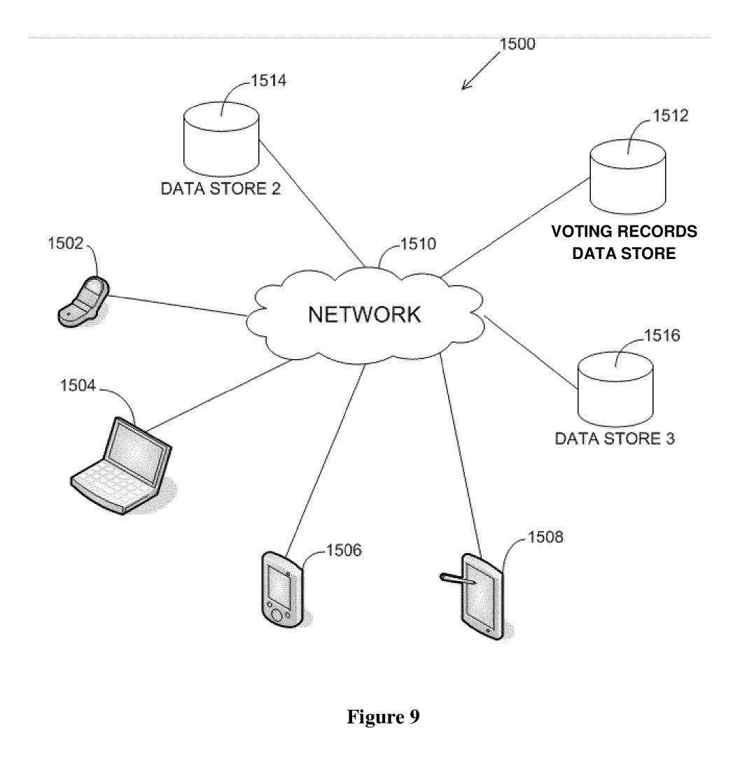

Some embodiments may be used in connection with at least one networked computer system such as the computer system 1500 illustrated in FIG. 9. The computer system 1500 comprises a plurality of computing devices including, but not limited to a cellular phone 1502, a laptop 1504, a PDA 1506, and a tablet computer 1508. Other suitable devices, such as a smart phone, may be used. Each of these computing devices may be connected to a plurality of data sets via network 1510 using one or more wired or wireless connections. For example, network 1510 may be the Internet and each of the computing devices may comprise software and/or hardware configured to access the Internet using one or more wired or wireless connections. The computer system 1500 may include a plurality of data stores accessible to network 1510 and configured to store data sets comprising group members' previous voting records, prior meeting minutes and meeting records, and one or more defined parliamentary procedures as described herein. In some embodiments, the plurality of data stores includes at least one voting records data store 1512 configured to store voting records of group members, including correlations of voting records between group members. The plurality of data stores may also include data stores (e.g., data store 1514 and data store 1516) configured to store other information related to parliamentary procedure or historical data. Embodiments are not limited by the number of data stores and computing devices in computer system 1500. For example, in some embodiments, all computing devices and data stores connected to the Internet may be considered as part of computer system 1500.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having thus described several aspects of embodiments of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A computer-readable storage medium encoded with a plurality of instructions that, when executed by a computer, perform a method comprising:
(a) receiving an indication of a first parliamentary action;
(b) based on at least the indication of the first parliamentary action, determining one or more available parliamentary actions which would be compliant with a defined set of parliamentary rules; and
(c) outputting an indication of at least one of the one or more available parliamentary actions.

2. A computer-readable storage medium as in claim 1, wherein the method further comprises:
(d) determining a presentation arrangement of the available parliamentary actions based on a defined hierarchy of rank of parliamentary actions;
(e) outputting an indication of the presentation arrangement determined in act (d).

3. A computer-readable storage medium as in claim 2, wherein act (d) comprises determining a presentation order of the available parliamentary actions.

4. A computer-readable storage medium as in claim 1, wherein the method further comprises:
(d) determining a presentation arrangement of the available parliamentary actions based on data regarding a frequency of prior use of the parliamentary actions;
(e) outputting an indication of the presentation arrangement determined in act (d).

5. A computer-readable storage medium as in claim 1, further comprising:
(f) receiving an indication of a user goal; and
(g) determining a presentation arrangement of the available parliamentary actions based on the user goal.

6. A computer-readable storage medium as in claim 1, further comprising:
(f) determining a user goal based on one or more parameters; and
(g) determining a presentation arrangement of the available parliamentary actions based on the user goal.

7. A computer-readable storage medium as in claim 1, further comprising:
(h) receiving an indication of a selection of one of the parliamentary actions; and
(i) outputting an indication of a form template associated with the selected parliamentary action, the form template having fields to be completed by a user.

8. A computer-readable storage medium as in claim 7, wherein the fields comprise menus for selection of a field-completing entry.

9. A computer-readable storage medium as in claim 1, further comprising outputting, for at least one of the one or more available parliamentary actions, information regarding potential outcomes of each of the at least one available parliamentary actions.

10-17. (canceled)

18. A computer system comprising:
at least one processor programmed to:
receive an indication of a first parliamentary action from a first client device;
determine one or more available parliamentary actions based on the first parliamentary action; and
send an indication of the first parliamentary action and an indication of the one or more available parliamentary actions to a plurality of client devices.

19. A computer system as in claim 18, wherein the processor is programmed to:
receive an indication of a second parliamentary action from a second client device, the second client device being different from the first client device, and the second parliamentary action being a selection from among the one or more available parliamentary actions that was determined based on the first parliamentary action.

20-27. (canceled)

28. A computer-readable storage medium encoded with a plurality of instructions that, when executed by a computer, perform a method comprising:
(a) receiving an indication of a first parliamentary action;
(b) receiving an indication of a second parliamentary action;
(c) recording, on a computer storage medium, the existence of the first parliamentary action;
(d) recording, on the computer storage medium, meta-data associated with the first parliamentary action;
(e) recording, on a computer storage medium, the existence of the second parliamentary action;
(f) recording, on the computer storage medium, meta-data associated with the second parliamentary action; and
(g) creating an electronic record of meeting minutes including the meta-data associated with the first and second parliamentary actions.

29. A computer-readable storage medium as in claim 28, wherein act (a) comprises receiving an indication of a first parliamentary action from a first member of a group of members which is using the defined set of parliamentary rules.

30. A computer-readable storage medium as in claim 29, wherein the first member is a chair of the group.

31. A computer-readable storage medium as in claim 29, wherein the first member is not a chair of the group.

32. A computer-readable storage medium as in claim 31, wherein act (b) comprises receiving an indication of a second parliamentary action from a second member of the group, wherein the second member is not a chair of the group.

33. A computer-readable storage medium as in claim 28, wherein the meta-data associated with the first parliamentary action comprises information regarding who proposed the parliamentary action.

34. A computer-readable storage medium as in claim 28, wherein the meta-data associated with the first parliamentary action comprises information regarding a time at which the parliamentary action was proposed.

35. A computer-readable storage medium as in claim 29, wherein the indication of a first parliamentary action from a first member comprises an indication created when the first member input electronically put forth the action.

36. A computer-readable storage medium as in claim 28, wherein the method further comprises linking the electronic record to an external database.

37. A computer-readable storage medium as in claim 28, wherein act (g) comprises updating the electronic record each time an indication of a parliamentary action is received.

38. A computer-readable storage medium as in claim 29, wherein the method further comprises sending an indication to update a display of the electronic record to each of a plurality of electronic devices, each of the plurality of electronic devices being associated with a member of the group of members.

39-44. (canceled)

45. A computer system comprising:
a first client device having at least one processor programmed to:
receive an indication of one or more available parliamentary actions from a central processor;
cause the display the one or more available parliamentary actions;
receive an input from a user, the input comprising an indication of a first parliamentary action from among the one or more parliamentary actions; and
send an indication of a first parliamentary action from among the one or more parliamentary actions to the central processor.
